(19) United States
(12) Patent Application Publication
(10) Pub. No.: US 2022/0315143 A1
(43) Pub. Date: Oct. 6, 2022

(54) WHEEL FRAME ADJUSTMENT MECHANISM OF CARRYING RACK

(71) Applicant: YOTTA INNOVATION CO., LTD., Apia (WS)

(72) Inventor: Stella Huang, Taipei City (TW)

(21) Appl. No.: 17/220,956

(22) Filed: Apr. 2, 2021

(51) Int. Cl. B62H 5/00; B62H 3/12

(52) U.S. Cl. CPC B62H 5/005; B62H 3/12

(57) ABSTRACT

A wheel frame adjustment mechanism of a carrying rack is provided, including: a guide member, configured to be arranged on a wheel frame and adjustably and positionably connected to a guide rod, including a main body and at least one friction-reducing member arranged on the main body, the at least one friction-reducing member being engaged with the guide rod, the guide member being releasably secured to the guide rod and adjustable and positionable along the guide rod; a locking member, connected with the guide member, being operable between a locking position and a release position, wherein when the locking member is in the locking position, the guide member and the guide rod are positioned and non-movable relative to each other, and when the locking member is in the release position, the guide member and the guide rod being movable relative to each other.

### BACKGROUND OF THE INVENTION

### Field of the Invention

The present invention relates to a wheel frame adjustment mechanism of a carrying rack.

### Description of the Prior Art

Bicycle not only can be used for commute but also has the effects of fitness and relief. Many people would drive to scenic resorts on holidays, and then ride bicycles to enjoy the beautiful scenery. The demand for bicycle carriers is therefore increasing.

In order to facilitate carrying the bicycle, a bicycle rack is usually installed at the rear of the vehicle for placing the bicycle. The bicycle rack generally includes a carrier frame and a plurality of wheel frames arranged on the carrier frame. The wheel frame is usually designed to be adjustable along a rod member of the bicycle rack to meet various needs for bicycles of different types.

Conventionally, the wheel frame is hooped on the rod body through a C-shaped member, and the adjustment is carried out by tightening or releasing the C-shaped member. However, when the C-shaped member is moved and adjusted relative to the rod body, the friction is great, it is not easy to move, and it is easy to wear, due to the large contact area between the C-shaped member and the rod body.

The present invention is, therefore, arisen to obviate or at least mitigate the above-mentioned disadvantages.

### SUMMARY OF THE INVENTION

The main object of the present invention is to provide a wheel frame adjustment mechanism of a carrying rack which lowers friction and is easy to adjust.

To achieve the above and other objects, a wheel frame adjustment mechanism of a carrying rack is provided, including: a guide member, configured to be arranged on a wheel frame and adjustably and positionably connected to a guide rod, including a main body and at least one friction-reducing member arranged on the main body, the at least one friction-reducing member being engaged with the guide rod, the guide member being releasably secured to the guide rod and adjustable and positionable along the guide rod; a locking member, connected with the guide member, being operable between a locking position and a release position, wherein when the locking member is in the locking position, the guide member and the guide rod are positioned and non-movable relative to each other, and when the locking member is in the release position, the guide member and the guide rod being movable relative to each other.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram showing a carrying rack of a preferable embodiment of the present invention;

FIG. 2 is a stereogram of a first preferable embodiment of the present invention;

FIG. 3 is a breakdown drawing of FIG. 2;

FIG. 4 is a side view of FIG. 2;

FIG. 5 is a partial enlargement of FIG. 4;

FIG. 6 is a stereogram of a second preferable embodiment of the present invention;

FIG. 7 is a breakdown drawing of FIG. 6;

FIG. 8 is a partial enlargement of FIG. 6;

FIG. 9 is a stereogram of a third preferable embodiment of the present invention;

FIG. 10 is a breakdown drawing of FIG. 9; and

FIG. 11 is a partial enlargement of FIG. 9.

### DETAILED DESCRIPTION OF THE PREFERRED EMBODIMENTS

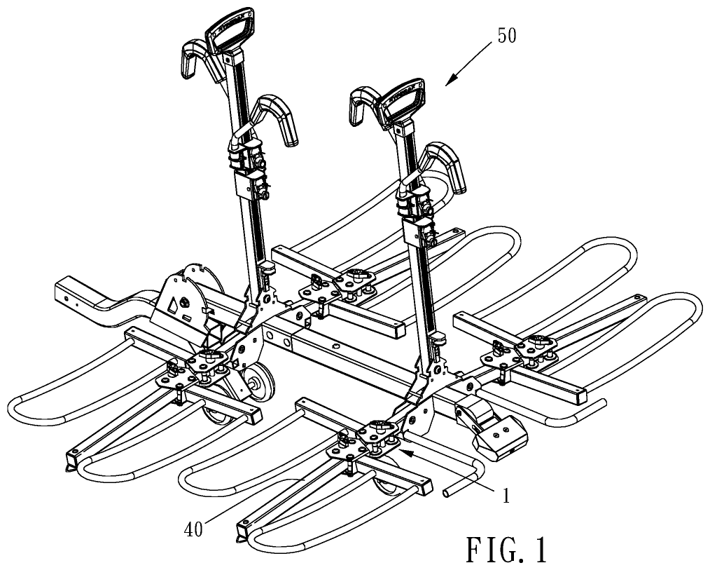

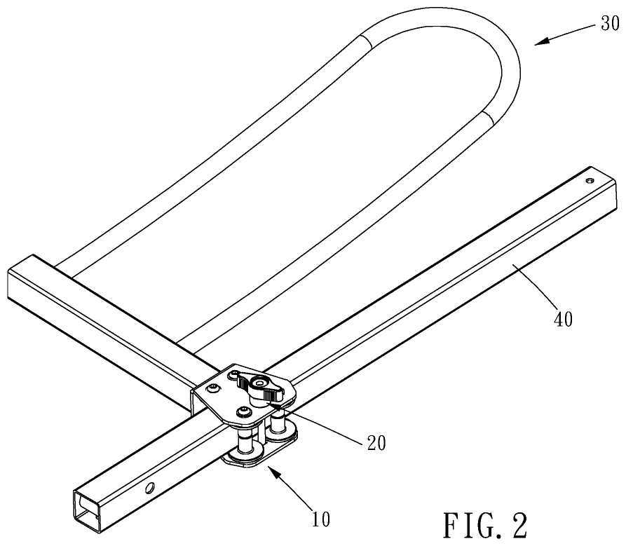

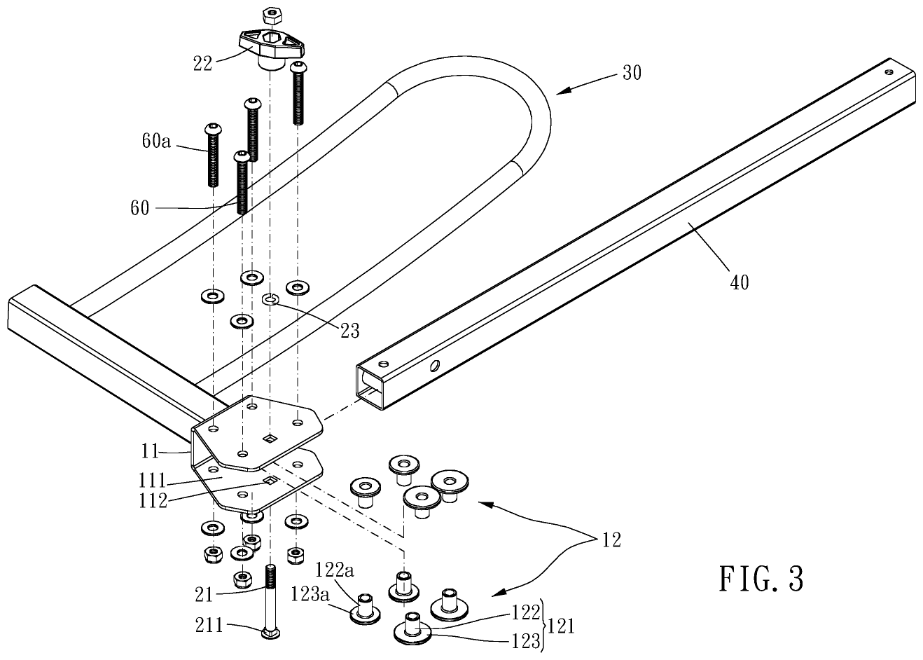

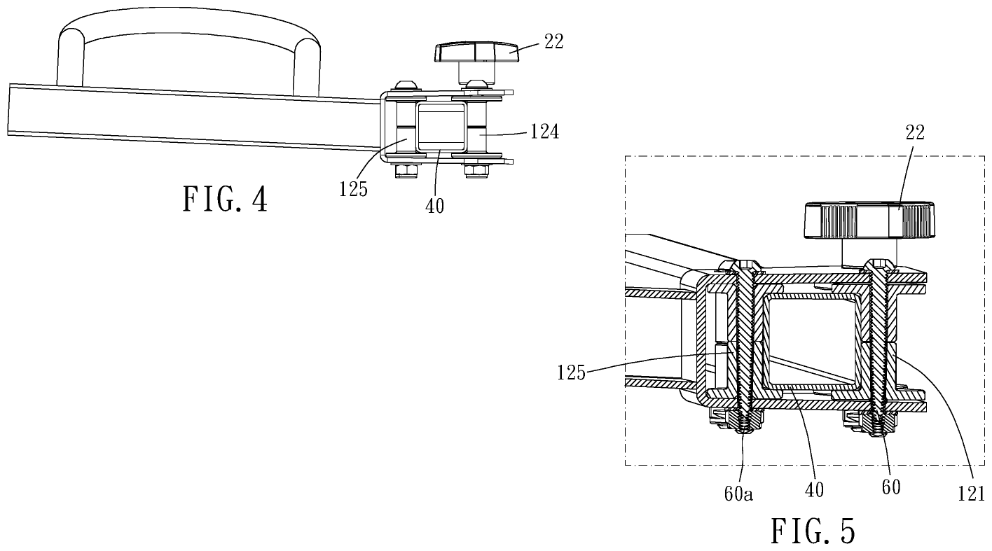

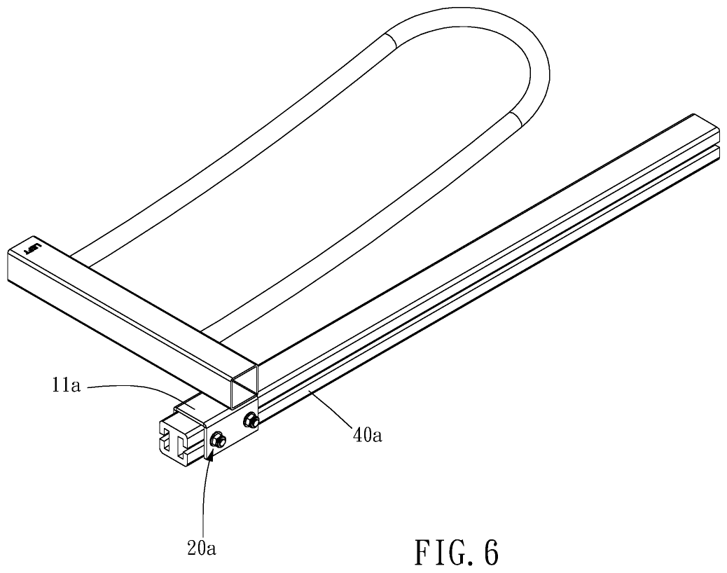

Please refer to FIGS. 1 to 5 for a preferable embodiment of the present invention. A wheel frame adjustment mechanism of a carrying rack 1 of the present invention includes a guide member 10 and a locking member 20.

The guide member 10 is configured to be arranged on a wheel frame 30 and is adjustably and positionably connected to a guide rod 40. The guide rod 40 is configured to be arranged on a carrying frame 50. The guide member 10 includes a main body 11 and at least one friction-reducing member 12 arranged on the main body 11, the at least one friction-reducing member 12 is engaged with the guide rod 40, and the guide member 10 is releasably secured to the guide rod 40 and adjustable and positionable along the guide rod 40. The locking member 20 is connected with the guide member 10 and operable between a locking position and a release position. When the locking member 20 is in the locking position, the guide member 10 and the guide rod 40 are positioned and non-movable relative to each other, and when the locking member 20 is in the release position, the guide member 10 and the guide rod 40 are movable relative to each other. Whereby, there is less friction between the guide member 10 and the guide rod 40, which is easy to adjust and significantly reduce wearing.

The at least one friction-reducing member 12 includes at least one roller 121, and the at least one roller 121 is in rolling contact with the guide rod 40. However, the at least one friction-reducing member 12 may include at least one convex face, tip or the like which can lower friction. Preferably, the at least one friction-reducing member 12 includes a plurality of said rollers 121, and the plurality of rollers 121 are correspondingly arranged on the main body 11, which balances and stably abuts the guide rod 40 and evenly distributes stress. Specifically, the locking member 20 includes a first shaft 21 mounted to the main body 11 and an adjustable member 22 adjustably connected with the first shaft 21. Each said roller 121 includes a first tubular member 122 rotatably disposed around a first axle 60 and a first flange 123 extending radially from the first tubular member 122, the first axle 60 is connected to the main body 11, and the first flange 123 faces the guide rod 40. When the adjustable member 22 is moved and adjusted relative to the first shaft 21 and the locking member 20 is in the locking position, the first flange 123 is urged and clamped between the main body 11 and the guide rod 40. The roller 121 may be provided without the first flange 123, wherein the first tubular member 122 may be abutted against the guide rod 40 so that the main body 11 is configured to urge the guide rod 40.

Specifically, the main body 11 includes two side walls 111 at opposite sides of the guide rod 40, at least one of the two side walls 111 includes a non-circular through hole 112, an end portion of the first shaft 21 includes a non-circular portion 211, the first shaft 21 is disposed through the two side walls 111, and the non-circular portion 211 is non-rotatably inserted within the non-circular through hole 112. In this embodiment, the first shaft 21 is a threaded member, and the adjustable member 22 is screwed with the threaded member, for easy adjustment and urging. The first shaft 21 and the adjustable member 22 may be provided in a quick-release or eccentric urging mechanism. Preferably, a spring washer 23 or the like is disposed around the first shaft 21, and the spring washer 23 is located between the adjustable member 22 and a the side wall 111, which prevents unstable engagement of the adjustable member 22 and the first shaft 21 due to external force.

Specifically, the plurality of rollers 121 are correspondingly arranged at opposite sides of the main body 11; the plurality of rollers 121 includes two first rollers 124 and a plurality of second rollers 125; the first axle 60 is disposed through the two first rollers 124, the first flanges 123 of the two first rollers 124 overlap the two side walls 111 of the guide rod 40, respectively; every pair of the plurality of second rollers 125 is penetrated by a second axle 60a disposed on the main body 11, each of the plurality of second rollers 125 includes a second tubular member 122a rotatably disposed around the second axle 60a and a second flange 123a extending radially from the second tubular member 122a, the second axle 60a is connected to the main body 11, and the first flange 123 has a radial extent larger than a radial extent of at least one the second flange 123a, which provides effective and sufficient urging; the second flanges 123a of the plurality of second rollers 125 overlap the two side walls 111 of the guide rod 40; the guide rod 40 is encompassed by the first flanges 123 of the two first rollers 124 and the second flanges 123a of the plurality of second rollers 125. Whereby, there is less friction, the guide member 10 and the guide rod 40 can contact and abut each other stably, and the stress can be evenly distributed.

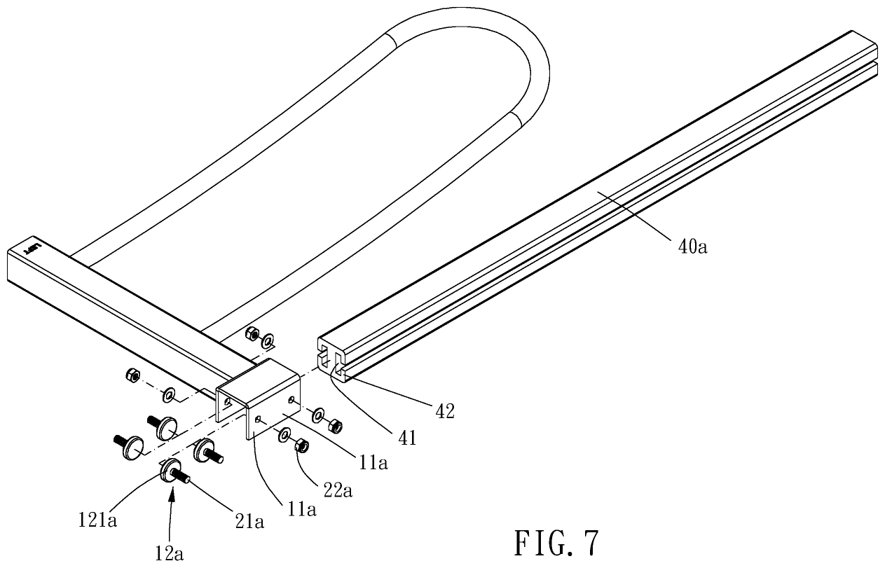

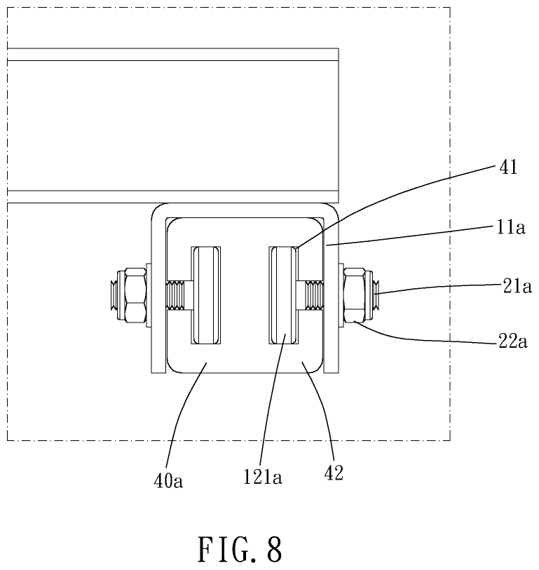

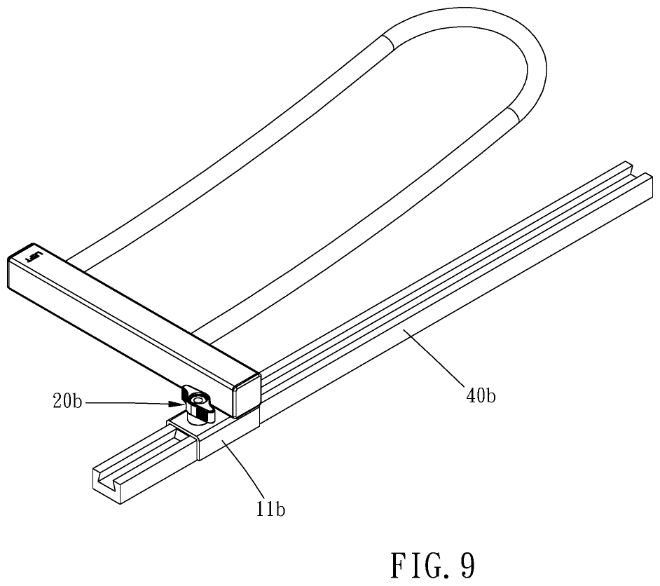

In a second embodiment shown in FIGS. 6 to 8, the guide rod 40a includes at least one guiding groove 41, the locking member 20a includes a first shaft 21a connected with the at least one roller 121a and an adjustable member 22a adjustably connected with the first shaft 21a, and the at least one roller 121a is engaged within the at least one guiding groove 41. It is noted that the roller 121a may be movable with or relative to the first shaft 21a. When the adjustable member 22a is moved and adjusted relative to the first shaft 21a and the locking member 20a is in the locking position, a portion of the main body 11a is urged and clamped between the adjustable member 22a and the guide rod 40a. Specifically, the guide rod 40a further includes at least one C-shaped portion 42 defining the at least one guiding groove 41, the at least one roller 121a is received in the at least one C-shaped portion 42, the first shaft 21a is disposed through the C-shaped portion 42 and a side wall of the main body 11a, the side wall of the main body 11a is urged and clamped between the at least one C-shaped portion 42 and the adjustable member 22a. Preferably, the wheel frame adjustment mechanism includes a plurality of said guiding grooves 41, a plurality of said friction-reducing member 12a and a plurality of said locking members 20a, and thus the structure is strong and stable, and there is less friction.

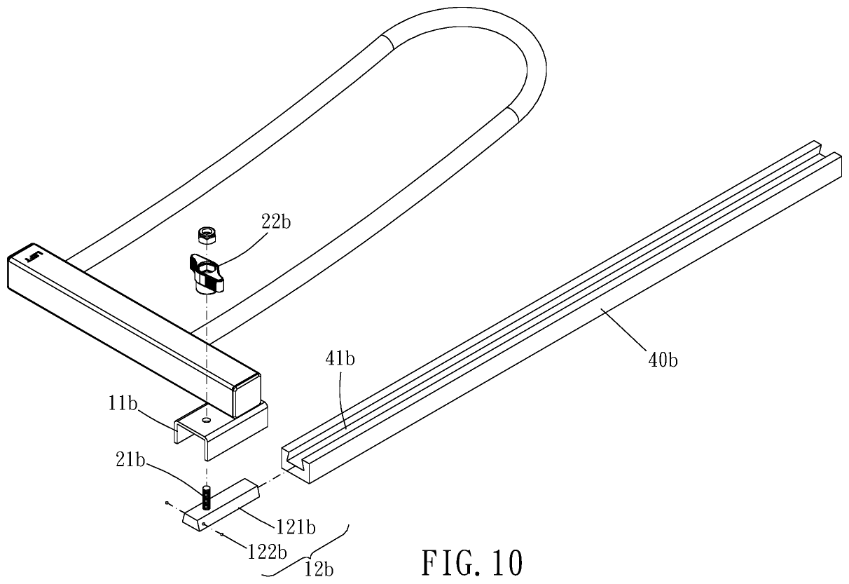

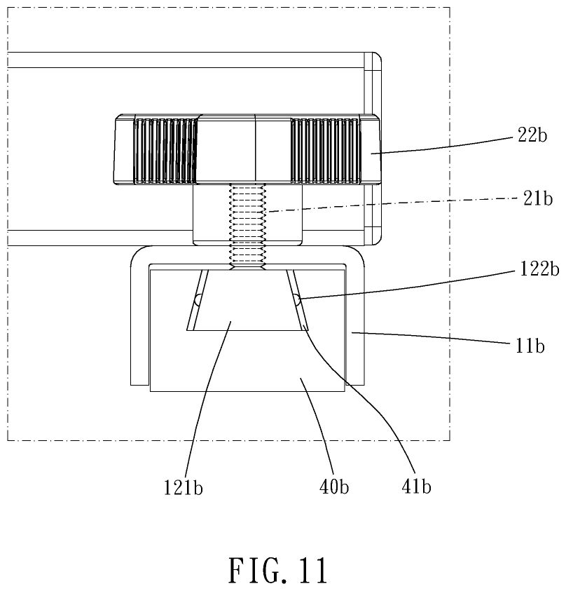

In a third embodiment shown in FIGS. 9 to 11, the guide rod 40b includes a guiding groove 41b, the main body 11b covers the guiding groove 41b, the at least one friction-reducing member 12b further includes a guide block 121b engaged within the at least one guiding groove 41b and at least one projecting member 122b on the guide block 121b and contacts an inner wall of the guiding groove 41b. The projecting member 122b may be movable with or relative to the guide block 121b, or the projecting member 122b and the guide block 121b may integrally formed of one piece. The locking member 20b includes a first shaft 21b connected with the guide block 121b and an adjustable member 22b adjustably connected with the first shaft 21b. When the adjustable member 22b is moved and adjusted relative to the first shaft 21b and the locking member 20b is in the locking position, the adjustable member 22b and the at least one projecting member 122b is urged and abutted against the main body 11b and the inner wall of the guiding groove 41b at opposite sides of the main body 11b. The projecting member 122b may be provided to be elastically retractable within the guide block 121b so that the guide block 121b can contact and urge the inner wall of the guiding groove 41b in surface contact with large area, which enhances urging and positioning effect.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A wheel frame adjustment mechanism of a carrying rack, including:
a guide member, configured to be arranged on a wheel frame and adjustably and positionably connected to a guide rod, including a main body and at least one friction-reducing member arranged on the main body, the at least one friction-reducing member being engaged with the guide rod, the guide member being releasably secured to the guide rod and adjustable and positionable along the guide rod;
a locking member, connected with the guide member, being operable between a locking position and a release position, wherein when the locking member is in the locking position, the guide member and the guide rod are positioned and non-movable relative to each other, and when the locking member is in the release position, the guide member and the guide rod being movable relative to each other.

2. The wheel frame adjustment mechanism of the carrying rack of claim 1, wherein the at least one friction-reducing member includes at least one roller, and the at least one roller is in rolling contact with the guide rod are.

3. The wheel frame adjustment mechanism of the carrying rack of claim 2, wherein the at least one friction-reducing member includes a plurality of said rollers, and the plurality of rollers are correspondingly arranged on the main body.

4. The wheel frame adjustment mechanism of the carrying rack of claim 2, wherein the locking member includes a first shaft mounted to the main body and an adjustable member adjustably connected with the first shaft, each said roller includes a first tubular member rotatably disposed around a first axle and a first flange extending radially from the first tubular member, the first axle is connected to the main body, the first flange faces the guide rod, and when the adjustable member is moved and adjusted relative to the first shaft and the locking member is in the locking position, the first flange is urged and clamped between the main body and the guide rod.

5. The wheel frame adjustment mechanism of the carrying rack of claim 4, wherein the main body includes two side walls at opposite sides of the guide rod, at least one of the two side walls includes a non-circular through hole, an end portion of the first shaft includes a non-circular portion, the first shaft is disposed through the two side walls, and the non-circular portion is non-rotatably inserted within the non-circular through hole.

6. The wheel frame adjustment mechanism of the carrying rack of claim 5, wherein a spring washer is disposed around the first shaft, and the spring washer is located between the adjustable member and one of the two side walls.

7. The wheel frame adjustment mechanism of the carrying rack of claim 2, wherein the guide rod includes at least one guiding groove, the locking member includes a first shaft connected with the at least one roller and an adjustable member adjustably connected with the first shaft, the at least one roller is engaged within the at least one guiding groove, and when the adjustable member is moved and adjusted relative to the first shaft and the locking member is in the locking position, a portion of the main body is urged and clamped between the adjustable member and the guide rod.

8. The wheel frame adjustment mechanism of the carrying rack of claim 7, wherein the guide rod further includes at least one C-shaped portion defining the at least one guiding groove, the at least one roller is received in the at least one C-shaped portion, the first shaft is disposed through the C-shaped portion and a side wall of the main body, and the side wall of the main body is urged and clamped between the at least one C-shaped portion and the adjustable member.

9. The wheel frame adjustment mechanism of the carrying rack of claim 2, wherein the guide rod includes a guiding groove, the main body covers the guiding groove, the at least one friction-reducing member further includes a guide block engaged within the at least one guiding groove and at least one projecting member on the guide block and contacts an inner wall of the guiding groove, the locking member includes a first shaft connected with the guide block and an adjustable member adjustably connected with the first shaft, when the adjustable member is moved and adjusted relative to the first shaft and the locking member is in the locking position, the adjustable member and the at least one projecting member is urged and abutted against the main body and the inner wall of the guiding groove at opposite sides of the main body.

10. The wheel frame adjustment mechanism of the carrying rack of claim 6, wherein the at least one friction-reducing member includes a plurality of said rollers, and the plurality of rollers are correspondingly arranged on the main body; the plurality of rollers includes two first rollers and a plurality of second rollers; the first axle is disposed through the two first rollers, the first flanges of the two first rollers overlap the two side walls of the guide rod, respectively; every pair of the plurality of second rollers is penetrated by a second axle disposed on the main body, each of the plurality of second rollers includes a second tubular member rotatably disposed around the second axle and a second flange extending radially from the second tubular member, the second axle is connected to the main body, the first flange has a radial extent larger than a radial extent of at least one said second flange; the second flanges of the plurality of second rollers overlap the two side walls of the guide rod, respectively; the guide rod is encompassed by the first flanges of the two first rollers and the second flanges of the plurality of second rollers.
